(19) United States
(12) Patent Application Publication
(10) Pub. No.: US 2024/0208619 A1
(43) Pub. Date: Jun. 27, 2024

(54) A SEMI-SUBMERSIBLE SERVICE VESSEL FOR A FLOATING INSTALLATION AND METHOD THEREFOR

(71) Applicant: OSK - FLOATING WIND APS, Aarhus C, DENMARK, Aarhus C (DK)

(72) Inventor: Steen Tange HASHOLT, Alleroed (DK)

(73) Assignee: OSK - FLOATING WIND APS, Aarhus C (DK)

(21) Appl. No.: 18/553,222

(22) PCT Filed: Mar. 28, 2022
(86) PCT No.: PCT/DK2022/050062

§ 371 Date: Sep. 29, 2023

(30) Foreign Application Priority Data
Mar. 30, 2021 (DK) PA202100330

(51) Int. Cl. B63B 35/44; B63B 1/10; B63B 77/10

(52) U.S. Cl. CPC B63B 35/44; B63B 1/107; B63B 77/10; B63B 2035/442; B63B 2035/446

(57) ABSTRACT

A semi-submersible service vessel (100) for a floating installation (102) has a hull (104) and a ballasting system. The ballasting system is arranged to selectively lower the hull (104) to a first draft and raise the hull (104) to a second draft. The second draft is smaller than the first draft. At least one submersed elongate lifting fork is fixed to the hull (104) and is configured to extend across the underside of the floating installation (102) and engage the underside of the floating installation (102) when the hull (104) is raised from the first draft to the second draft. Wherein the at least one lifting fork is arranged to lift the entire floating installation (102) when the hull (104) is raised from the first draft to the second draft, and a method of servicing a floating installation (102) with a semi-submersible service vessel (100).

### CROSS-REFERENCE TO RELATED APPLICATION(S)

This application is the National Phase under 35 U.S.C. § 371 of PCT International Application No. PCT/DK2022/050062, which has an international filing date of Mar. 28, 2022, which designated the United States of America and which claims priority to Danish Patent Application No. PA202100330, filed Mar. 30, 2021, the entire contents of each of which are incorporated herein by reference.

### TECHNICAL FIELD

The present disclosure relates to a semi-submersible service vessel for a floating installation and method therefor. In particular, the present disclosure relates to semi-submersible service vessel for a floating wind turbine and method therefor.

### BACKGROUND

Typically, electricity is generated from the wind with wind turbine generators installed in locations with a reliable prevailing wind. Some wind turbine generators have been installed on land in windy areas such as on hilltops. Wind turbine generators installed on land are also known as “onshore” wind turbine generators. However, larger wind turbine generators can be installed in coastal waters. Wind turbine generators installed in coastal waters, the sea or deep ocean are also known as “offshore” wind turbine generators.

Some offshore wind turbines are floating wind turbines which are tethered to the seafloor. Periodically, the floating wind turbines must undergo maintenance. Currently part of the maintenance process requires removing the tethers and then a service vessel or tug towing the floating wind turbine to a harbour. Towing the floating wind turbine requires a clear weather window when the sea is calm. This is time consuming and requires that the floating wind turbine is out of commission for the time that is required for towing and maintaining the floating wind turbine.

Alternatively, a service vessel can be fixed with respect to the floating wind turbine in position during maintenance as shown in WO2020/167137. A problem with the service vessel in WO2020/167137 is that the floating wind turbine is unstable when fixed to the service vessel and can dismount from service vessel during heavy seas due to the movement of the wind and waves. Accordingly, the service vessel of WO2020/167137 can only operate in very calm weather windows.

Examples described hereinafter aim to address the aforementioned problems.

### SUMMARY

Examples of the present disclosure aim to address the aforementioned problems.

According to an aspect of the present disclosure there is a semi-submersible service vessel for a floating installation having: a hull; a ballasting system arranged to selectively lower the hull to a first draft and raise the hull to a second draft, the second draft being smaller than the first draft; at least one submersed elongate lifting fork fixed to the hull and configured to extend across the underside of the floating installation and engage the underside of the floating installation when the hull is raised from the first draft to the second draft; wherein the at least one lifting fork is arranged to lift the entire floating installation when the hull is raised from the first draft to the second draft.

Optionally, the at least one fork is arranged to exert a resultant lifting force on the underside of the floating installation towards a centre of gravity of the floating installation when the hull is raised from the first draft to the second draft.

Optionally, the at least one submersed elongate lifting fork is an integral portion of the hull.

Optionally, the at least one lifting fork is a pair of lifting forks.

Optionally, each of the lifting forks comprises a lateral projection extending towards the other lifting fork.

Optionally, the lateral projection comprises a guide surface arranged to guide cables or mooring lines between the pair of lifting forks.

Optionally, the centre of gravity of the floating installation is positioned between the pair of lifting forks.

Optionally, the at least one lifting fork extends across the underside of the floating installation from a first side of the floating installation to a second side of the floating installation.

Optionally, the at least one lifting fork comprises at least one engagement surface configured to engage at least one reciprocal surface on the underside of the floating installation.

Optionally, the at least one engagement surface comprises a profile and the at least one reciprocal surface comprises a reciprocal profile.

Optionally, the at least one engagement surface and/or the at least one reciprocal surface comprise a dampener configured to absorb shocks between the at least one lifting fork and the floating installation.

Optionally, the dampener is a rubber fender.

Optionally, the at least one engagement surface and/or the at least one reciprocal surface comprise a recess for trapping water for dampening shocks between the at least one engagement surface and the at least one reciprocal surface when engaged.

Optionally, the floating installation is tethered to the seafloor via at least one mooring line.

Optionally, the tension in the at least one mooring line opposes the lifting force when the hull is raised to the second draft.

Optionally, the second draft of the hull corresponds to a predetermined threshold resultant lifting force.

Optionally, the ballasting system is configured move the hull from the second draft to a third draft and modify the resultant lifting force.

Optionally, the resultant lifting force is less than a threshold mooring line tension.

Optionally, the lifting force exerted by the at least one lifting fork does not cause a turning moment about the centre of gravity of the floating installation.

Optionally, the ballasting system is connectable to a one or more ballast tanks mounted on the floating installation and arranged to adjust ballast in the ballast tanks.

Optionally, the floating installation is a floating wind turbine.

In a second aspect of the disclosure, there is provided a method of servicing a floating installation with a semi-submersible service vessel comprising: positioning at least one submersed elongate lifting fork fixed to a hull of the semi-submersible service vessel such that the at least one submersed elongate lifting fork extends across the underside of the floating installation; actuating a ballasting system to raise the hull from a first draft a second draft; engaging the at least one submersed elongate lifting fork with the underside of the floating installation when the hull is raised from the first draft to the second draft; exerting a lifting force on the underside of the floating installation with the at least one lifting fork and lifting the entire floating installation when the hull is raised from the first draft to the second draft.

Optionally, the method comprises increasing the tension in at least one mooring line tethering the floating installation to the seafloor when the hull is raised from the first draft to the second draft.

### BRIEF DESCRIPTION OF THE DRAWINGS

Various other aspects and further examples are also described in the following detailed description and in the attached claims with reference to the accompanying drawings, in which:

FIG. 1 shows a perspective view of a semi-submersible service vessel and a floating installation according to an example;

FIG. 2 shows a perspective view of a floating installation according to an example;

FIG. 3 shows a perspective view of a semi-submersible service vessel according to an example;

FIG. 4 shows a perspective view of a semi-submersible service vessel and part of a floating installation according to an example;

FIG. 5 shows a plan view of a semi-submersible service vessel and a floating installation according to an example;

FIG. 6 shows a plan view of a semi-submersible service vessel according to an example;

FIGS. 7a and 7b show side views of a semi-submersible service vessel and a floating installation at different stages of engagement according to an example;

FIGS. 8a and 8b show a side view of a semi-submersible service vessel and the principles for different stages of engagement according to an example;

FIG. 9 shows a schematic cross-sectional side view of a semi-submersible service vessel and a floating installation according to an example;

FIG. 10 shows a schematic cross-sectional side view of a semi-submersible service vessel and a floating installation according to an example;

FIG. 11 shows a flow diagram of method according to an example;

FIG. 12 shows a close-up perspective view of a semi-submersible service vessel according to an example;

FIG. 13 shows a plan view of a semi-submersible service vessel according to an example; and

FIGS. 14a, 14b, and 14c respectively show plan views of semi-submersible service vessels according to different examples.

### DETAILED DESCRIPTION

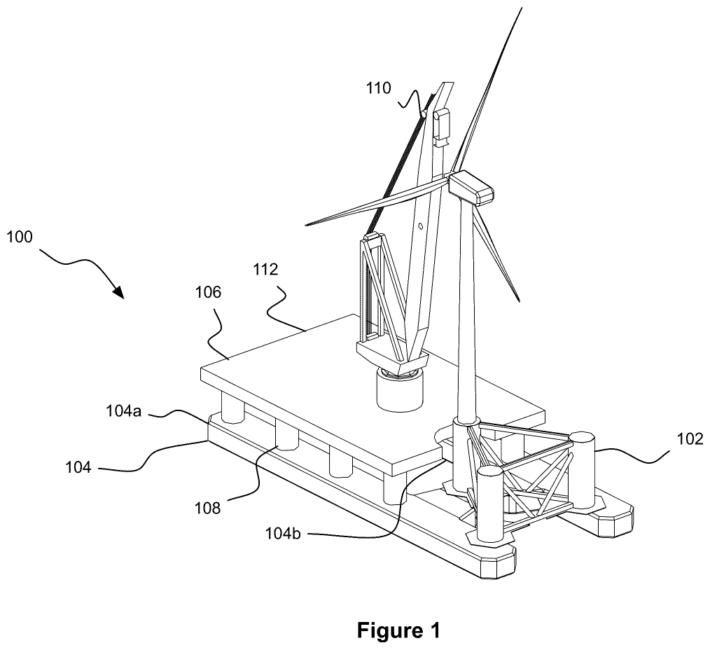

FIG. 1 shows a perspective view of a semi-submersible service vessel 100. As shown in FIG. 1, the semi-submersible service vessel 100 is engaged with a floating installation 102. The floating installation 102 as shown in FIG. 1 is a floating wind turbine 102.

Hereinafter, the floating installation 102 will be described using the term “floating wind turbine” 102, however in other examples, any other type of floating installation 102 can be engaged by the semi-submersible service vessel 100. For example, the floating installation 102 can be a floating substation, a pontoon, a moored barge, or any other type of floating installation a damaged vessel, a wave energy installation, floating farms (seaweed or fish). In some other examples, the floating installation 102 comprises a combination of wind power generation systems, wave power generation system, or another power generation, or a power storage system e.g. “power-2-X” system.

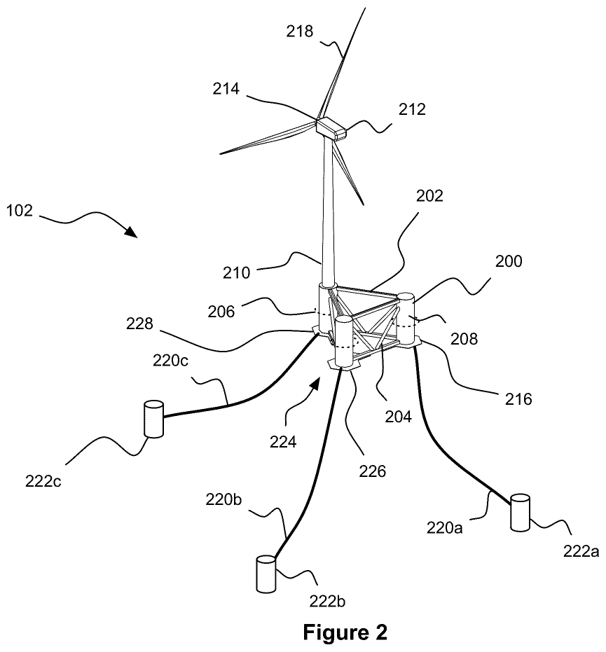

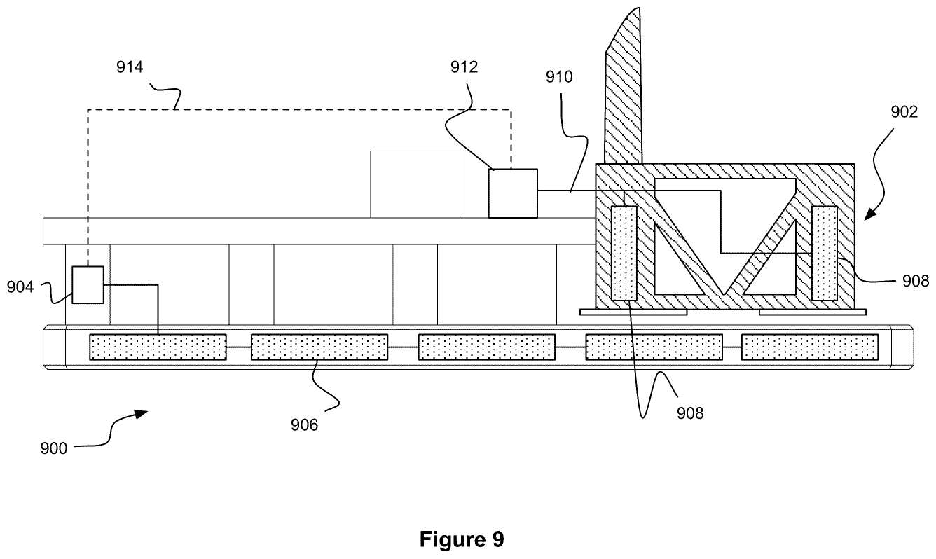

The floating wind turbine 102 will briefly be described with reference to FIG. 2. The floating wind turbine 102 comprises a semi-submersible floating support structure 200 which is partly submerged in operation. The waterline 206 is indicated on the floating support structure 200 with three dotted lines. The position of the waterline 206 on the floating support structure 200 is dependent on the wind turbine ballast system 902 (best shown in FIG. 9). The wind turbine ballast system 902 will be discussed in further detail below in connection with FIG. 9.

The floating support structure 200 as shown in FIG. 2 comprises three columns 208 which are connected with horizontal beams 202 and reinforcing braces 204. For the purposes of clarity only one column 208 is labelled in FIG. 2. One or more of the reinforcing braces 204 can be connected to a tower 210 of the floating wind turbine 102. The tower 210 is mounted on one of the columns 208. Each column 208 comprises a footplate 216, 226, 228 at the submerged end of the column 208.

The tower 210 can be a unitary element or can be constructed from a plurality of tower segments. A nacelle 212 is rotatably mounted on the top of the tower 210. The nacelle 212 can rotate about the vertical axis of the tower 210. The nacelle 212 houses a generator (not shown) for converting the rotation of a hub 214 and blades 218 into electrical energy. There may be a plurality of blades 218 connected to the hub 214. The generator is connected to an electrical substation via one or more cables (not shown).

The floating wind turbine 102 is moored in position with one or more mooring lines. FIG. 2 shows each footplate 216, 226, 228 respectively connected to a mooring line 220a, 220b, 220c. Each mooring line 220a, 220b, 220c is then respectively connected to an anchor 222a, 222b, 222c. The anchor 222a, 222b, 222c in some examples is fixed to the seafloor. The anchor 222a, 222b, 222c in some examples is a submerged concrete mass placed on or embedded in the seafloor. In other examples, the anchor can be any suitable anchoring means for attaching the mooring line 220a, 220b, 220c to.

The floating wind turbine 102 as shown in FIG. 2 has a semi-submersible floating support structure 200 with a generally triangular shape. That is, there are three columns 208, arranged at the corners of a triangle. However, in other examples, the floating wind turbine 102 can comprise different shapes and form factors. For example, in some examples there can be more than three columns. In this way, the semi-submersible floating support structure 200 can comprise a generally square, pentagonal, hexagonal etc. shape. Furthermore, in other examples there can be additional towers 210 and other wind turbine components mounted on more than one column.

Whilst the tower 210 is mounted on one of the columns 208 as shown in FIG. 2, the tower 210 can be mounted between two or more columns 208 and supported with the horizontal beams 202 and the reinforcing braces 204.

Furthermore, the floating wind turbine 102 as shown in FIG. 2 is a semi-submersible type of wind turbine. In other examples, the floating wind turbine 102 can be other types of floating wind turbine 102 such as an articulated multi-spar floating wind turbine or a tension-leg platform floating wind turbine or a barge platform floating wind turbine. Alternatively, the wind turbine can be mounted on a floating structure such as a barge or a pontoon.

Turning back to FIG. 1, the semi-submersible service vessel 100 will be described in more detail. The semi-submersible service vessel 100 comprises a hull 104. In some examples, the semi-submersible service vessel 100 comprises a dual hull arrangement having a first hull 104a and a second hull 104b. The dual hull arrangement as shown in FIG. 1, increases the beam of the semi-submersible service vessel 100 without significantly increasing the draft. This increases the stability of the semi-submersible service vessel 100. However, in other examples, the semi-submersible service vessel 100 comprises a monohull (not shown). In other yet further examples, the semi-submersible service vessel 100 can comprise a multihull arrangement with any number of hulls (not shown). Whilst the semi-submersible service vessel 100 as shown in FIG. 1 comprises a dual hull arrangement having a first and second hull 104a, 104b, hereinafter reference will be made to the term “hull” 104 unless specifically referring to the first and second hulls 104a, 104b separately. Nevertheless, the term hull 104 covers one, some or all of the hulls of the semi-submersible service vessel 100.

The semi-submersible service vessel 100 comprises a working deck 106 which is mounted to the hull 104 via a plurality of deck support columns 108. For the purposes of clarity, only one of the deck support columns 108 is labelled in FIG. 1. The working deck 106 is arranged to store equipment, tools, and parts for the purposes of maintaining the floating wind turbine 102. The working deck 106 in some examples can provide space for storing spare parts (not shown) and equipment for the floating wind turbine 102. The spare parts can be wind turbine blades 218, nacelles 212, tower 210 sections or any other parts and equipment for the floating wind turbine 102. The spare parts can be fastened to the working deck 106 via sea fastenings to ensure that the spare parts remain fixed to the working deck 106 whilst the semi-submersible service vessel 100 is sailing.

The working deck 106 comprises a crane 110 for lifting and moving equipment and parts about the working deck 106 and to and from the floating wind turbine 102. Whilst FIG. 1 shows a single crane 110 mounted in the centre of the working deck 106, there can be additional cranes (not shown) mounted in different locations on the working deck 106. For example, the crane 110 can be mounted to one side of the working deck 106 in order to provide more space for large parts and equipment. In other examples there can be two cranes (not shown) mounted on each side of the working deck 106. This can increase the lifting capacity and number of lifting jobs that can be completed on the semi-submersible service vessel 100. The crane 110 and its operation is known as will not be discussed in any further detail.

Although not shown, the working deck 106 can comprise one or more superstructures (not shown) providing the bridge, accommodation, and/or machinery required for the maintenance of the floating wind turbine 102. In some examples, the superstructure can be positioned at a first end 112 of the semi-submersible service vessel 100.

In some examples, the semi-submersible service vessel 100 comprises one or more propulsors (not shown) such as an azimuthing thruster, or propeller etc. for moving the semi-submersible service vessel 100 to a floating wind turbine 102. In an example, the semi-submersible service vessel 100 comprises four azimuthing thrusters (not shown) in each end of the first and second hulls 104a, 104b. Alternatively, in some examples, the semi-submersible service vessel 100 does not comprise propulsors and is towed by one or more tugboats (not shown) when the semi-submersible service vessel 100 is moved. In some examples, the tugboats can be connected to the semi-submersible service vessel 100 by towing lines and/or directly by a mechanical coupling (e.g. articouple). In some examples, the semi-submersible service vessel 100 is towed with another vessel e.g. tugboats to the floating wind turbine 102 whether or not the semi-submersible service vessel 100 comprises propulsors.

In order for the semi-submersible service vessel 100 to maintain a stationary position with respect to the seafloor e.g. the mooring position of the floating wind turbine 102, the semi-submersible service vessel 100 may comprise a dynamic positioning system (not shown) for controlling one or more propulsors. Additionally or alternatively, the semi-submersible service vessel 100 is maintained in position with one or more tugboats (not shown) tethered to the semi-submersible service vessel 100 via towing lines (not shown). The tugboats may comprise a dynamic positioning system for maintaining the position of the semi-submersible service vessel 100 with respect to the seafloor. Operation of a dynamic positioning system with the semi-submersible service vessel 100 or with one or more tugboats is known and will not be discussed any further.

The semi-submersible service vessel 100 comprises a ballasting system 900 arranged to adjust the draft of the semi-submersible service vessel 100. The ballasting system 900 also optionally controls the heel and trim of the semi-submersible service vessel 100. The ballasting system 900 is best shown in FIG. 9 and will be discussed in more detail below.

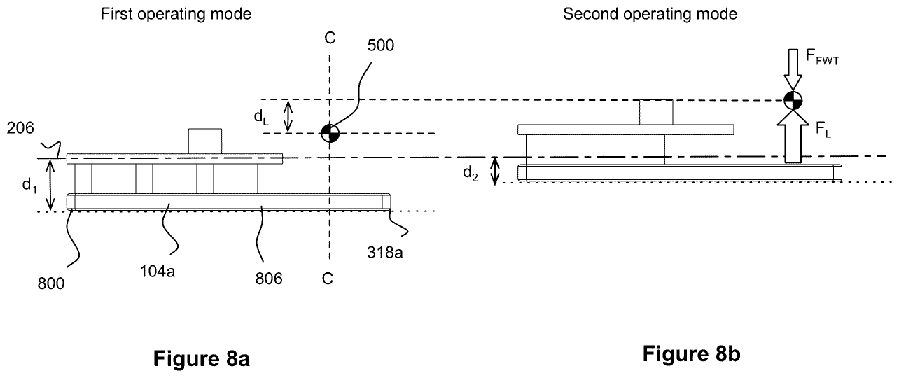

The ballasting system 900 allows the semi-submersible service vessel 100 to adjust the distance between the bottom of the hull 802 and the waterline 206 on the vessel. This will be discussed in more detail in reference to FIGS. 8a and 8b. FIGS. 8a and 8b show the semi-submersible service vessel 100 in two different operating modes. In a first operating mode, the hull 104 of the semi-submersible service vessel 100 comprises a first draft d1 whereby the semi-submersible service vessel 100 is more submerged in the water. In the first operating mode, the semi-submersible service vessel 100 is configured to move at least a part of the semi-submersible service vessel 100 underneath the floating wind turbine 102.

In a second operating mode, the hull 104 of the semi-submersible service vessel 100 comprises a second draft d2 whereby the semi-submersible service vessel 100 is less submerged and floats higher in the water. The second draft d2 is smaller than the first draft d1. In the second operating mode, the semi-submersible service vessel 100 is configured to lift the entire floating wind turbine 102. Accordingly, the ballasting system 900 semi-submersible service vessel 100 can adjust the draft of the semi-submersible service vessel 100 during the maintenance of the floating wind turbine 102. This will be discussed in further detail below.

The waterline 206 as shown in FIG. 8a is exemplary for showing the schematic differences between the first operating mode and the second operating mode of the semi-submersible service vessel 100. Indeed, the waterline 206 as shown in FIG. 8a in the first operating mode is part way up the working deck 106, however in other examples, the waterline 206 can be part way up the deck support columns 108 or the hull 104 as required. The difference between the second draft d2 and the first draft d1 in the second and first operating modes can be modified depending on the dimensions of the floating wind turbine 102. For example second draft d2 and the first draft d1 can be modified in dependence of the draft of the floating wind turbine 102 and the height that the semi-submersible service vessel 100 needs to lift the floating wind turbine 102.

In some examples the difference between the second draft d2 and the first draft d1 is 6 m. In other examples, the difference between the second draft d2 and the first draft d1 is any of 1 m, 2 m, 3 m, 4 m, 5 m, 6 m, 7 m, 8 m, 9 m, 10 m, 11 m, 12 m, 13 m, 14 m, or 15 m. In other examples, the difference between the second draft d2 and the first draft d1 is any other value, suitable for the floating wind turbine 102, and the semi-submersible service vessel 100 attending it.

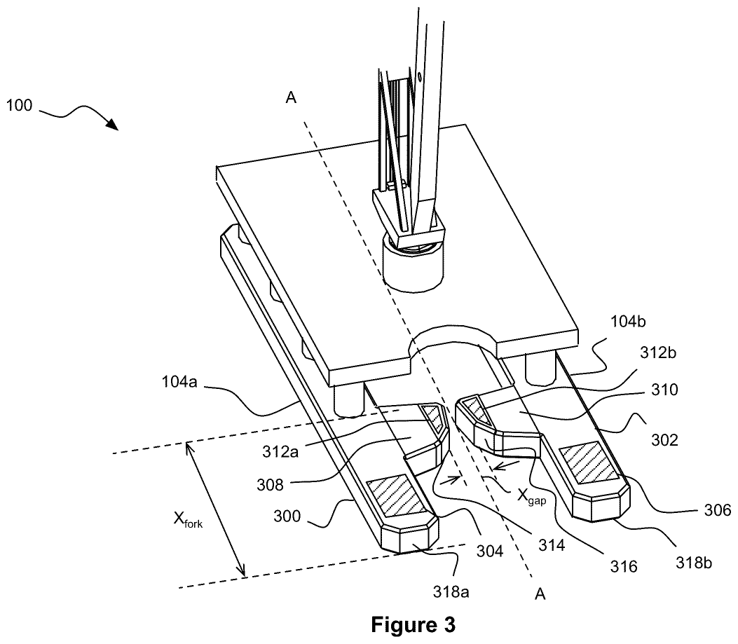

Turning to FIG. 3, the semi-submersible service vessel 100 will be discussed in further detail. FIG. 3 shows a partial perspective view of the semi-submersible service vessel 100.

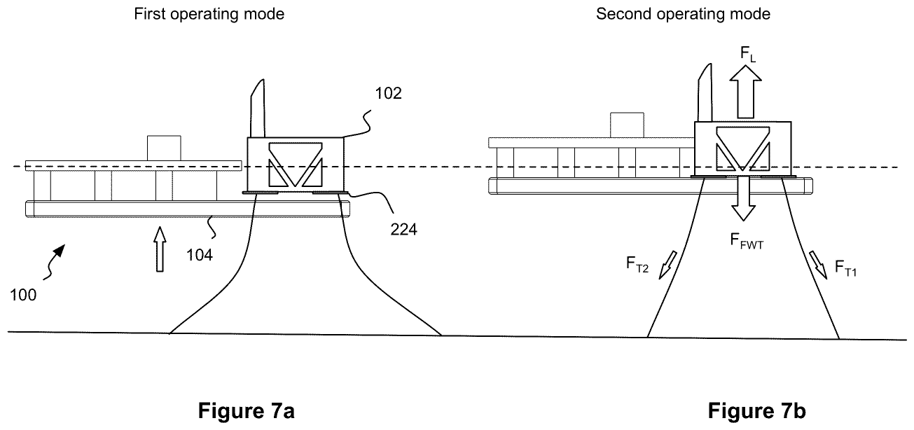

FIG. 3 more clearly shows the dual hull arrangement with the first and second hulls 104a, 104b. In some examples, the semi-submersible service vessel 100 comprises at least one submersed lifting fork 300, 302. As shown in FIG. 3, the semi-submersible service vessel 100 comprises a first submersed lifting fork 300 and a second submersed lifting fork 302. The first and second submersed lifting forks 300, 302 are configured to extend across an underside 224 of the floating wind turbine 102. That is, when the semi-submersible service vessel 100 is adjacent to the floating wind turbine 102 in the first operating mode, the first and second submersed lifting forks 300, 302 are positioned underneath the floating wind turbine 102. This can be better seen from FIG. 7a. FIG. 7a shows a side view of the semi-submersible service vessel 100 and the floating wind turbine 102 in the first operating mode.

The first and second submersed lifting forks 300, 302 are configured to engage the underside 224 of the floating wind turbine 102 when the hull 104 is raised from the first draft d1 to the second draft d2 and lift the floating wind turbine 102. This can be seen in more detail in FIG. 7b. FIG. 7b shows a side view of the semi-submersible service vessel 100 and the floating wind turbine 102 in the second operating mode. The lifting of the floating wind turbine 102 by the semi-submersible service vessel 100 will be discussed in more detail below.

Turning back to FIG. 3, the first and second submersed lifting forks 300, 302 will be discussed in more detail. In some examples, the first and second submersed lifting forks 300, 302 are respectively attached to the first hull 104a and the second hull 104b. In some examples and as shown in FIG. 3 the first and second submersed lifting forks 300, 302 are respectively integral with the first hull 104a and the second hull 104b. Indeed, the first hull 104a and the second hull 104b project forwards beyond the working deck 106 by distance Xfork.

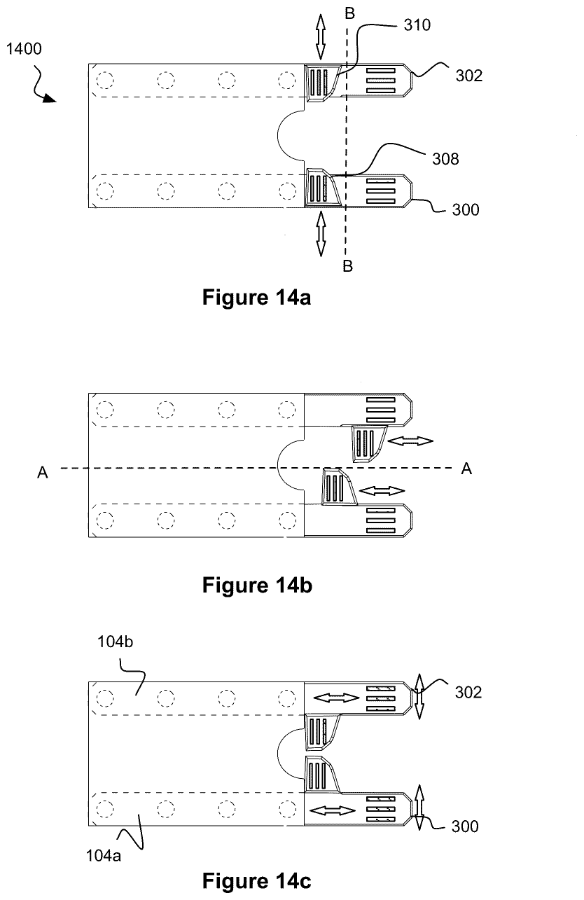

In some alternative examples, the first and second submersed lifting forks 300, 302 are respectively mounted to the first and second hulls 104a, 104b. The first and second submersed lifting forks 300, 302 can be respectively welded to first and second hulls 104a, 104b after the semi-submersible service vessel 100 has been built. This means that the semi-submersible service vessel 100 can be retrofitted with the first and second submersed lifting forks 300, 302. In some examples as shown in FIG. 3, the first and second submersed lifting forks 300, 302 are fixed with respect to the first and second hulls 104a, 104b. However, in some alternative examples (e.g. as described in reference to FIGS. 14a, 14b, 14c below) one or more portions of the first and second submersed lifting forks 300, 302 are moveable with respect to the first and/or the second hulls 104a, 104b.

In some examples, the first and second submersed lifting forks 300, 302 remain under the water in the first mode of operation when the hull 104 is at the first draft d1. In some examples, the first and second submersed lifting forks 300, 302 remain under the water in the second mode of operation when the hull 104 is at the second draft d2.

As mentioned above, the first and second submersed lifting forks 300, 302 extend across the underside 224 of the floating wind turbine 102. This ensures that the floating wind turbine 102 is stable and ensures a secure engagement between the semi-submersible service vessel 100 and the floating wind turbine 102. At least a portion of the first and second submersed lifting forks 300, 302 extends underneath a floating wind turbine centre of gravity 500.

In some examples the first and second submersed lifting forks 300, 302 comprise at least one engagement surface 304 for securely engaging the underside 224 of the floating wind turbine 102. The at least one engagement surfaces 304 is arranged to increase the friction between the first and second submersed lifting forks 300, 302 and the underside 224 to further prevent slipping between the semi-submersible service vessel 100 and the floating wind turbine 102. The first and second submersed lifting forks 300, 302 respectively comprise a first and second engagement surface 304, 306. The first and second engagement surfaces 304, 306 are positioned at a free end 318a, 318b of the first and second submersed lifting forks 300, 302. This means that the first and second engagement surfaces 304, 306 are positioned to engage the underside 224 of the floating wind turbine 102.

For example, the first and second engagement surfaces 304, 306 are optionally arranged to engage the underside of a first footplate 216 and a second footplate 226 mounted at a submerged end of two of the columns 208 in the semi-submersible floating support structure 200. In other examples, the first and second engagement surfaces 304, 306 are arranged to engage any surface on the underside 224 of the floating wind turbine 102.

The engagement surfaces 304, 306 are optionally shaped and size to match the features on the underside 224 of the floating wind turbine 102. For example, the engagement surfaces 304, 306 are a similar area, diameter, and or shape to the first and second footplates 216, 226. In some examples, the engagement surfaces 304, 306 comprise a recess for receiving the first and second footplates 216, 226. Accordingly the first and second footplates 216, 226 can be positively seated in the engagement surfaces 304, 306 when the semi-submersible service vessel 100 is in the second operating mode.

The first and second submersed lifting forks 300, 302 can further comprise additional engagement surfaces. In some examples the first and second submersed lifting forks 300, 302 respectively comprise a first and second lateral projection 308, 310 having third engagement surfaces 312a, 312b. The third engagement surfaces 312a, 312b are the same as the first and second engagement surfaces 304, 306 described above and configured to engage the underside 224 of the floating wind turbine 102. For example, the third engagement surfaces 312a, 312b are arranged to engage the third footplate 228. Whilst FIG. 3 shows a pair of third engagement surfaces 312a, 312b each positioned on the first and second lateral projection 308, 310, in another example only one of the first or second lateral projections 308, 312 comprises the third engagement surface 312a, 312b. In this example, the first lateral projection 308 projects from the first hull 104a further than the second lateral projection 310 from the second hull 104b.

The first and second lateral projections 308, 310 are respectively mounted to the first and second submersed lifting forks 300, 302 and increase the surface area that contacts the underside 224 of the floating wind turbine 102. The first and second lateral projections 308, 310 in some examples are integral with the first and second hulls 104a, 104b. In other examples, the first and second lateral projections 308, 310 are a separate hull portion and fixed to the first and second submersed lifting forks 300, 302. The first and second lateral projections 308, 310 as shown in FIG. 3 are fixed with respect to the first and second submersed lifting forks 300, 302. However in some alternative examples, the first and second lateral projections 308, 310 are moveable with respect to the first and second submersed lifting forks 300, 302. This means that the configuration of the engagement surfaces 304, 306, 312a, 312b can be moved. This is discussed in more detail with respect to the examples as shown in FIGS. 14a, 14b, and 14c below.

FIG. 3 shows the first and second lateral projections 308, 310 extending sidewards from the first and second hulls 104a, 104b by the same amount. In some examples, the first and second lateral projections 308, 310 do not touch each other, but a separated by a distance Xgap about a centre axis A-A. The distance Xgap between the first and second lateral projections 308, 310 Xgap allows for a mooring line 220c to extend freely down from the floating wind turbine 102 without being snagged on the hull 104. This means that the mooring line 220c or electrical cables do not interfere with a lifting operation of the semi-submersible service vessel 100.

The first and second lateral projections 308, 310 optionally comprise a first and second guide surface 314, 316. The first and second guide surfaces 314, 316 may be curved and guide the mooring line 220c and/or cables attached to the floating wind turbine 102 to be positioned between the first and second lateral projections 308, 310. This means that the mooring line 220c and the cables will automatically be positioned between the first and second lateral projections 308, 310 when the first and second submersed lifting forks 300, 302 are positioned underneath the floating wind turbine 102.

As can be seen from FIG. 3, the engagement surfaces, 304, 306, 312a, 312b provide a substantially triangular arrangement for engaging the underside 224 of the floating wind turbine 102. The triangular arrangement of the engagement surface 304, 306, 312a, 312b corresponds to the triangular arrangement of the columns 208 and footplates 216, 226, 228 of the semi-submersible floating support structure 200.

In some other examples, the configuration of the engagement surfaces 304, 306, 312a, 312b can be modified and adapted to different floating wind turbines 102 with different configurations of the semi-submersible floating support structure 200. For example, some examples, the semi-submersible floating support structure 200 comprises a square arrangement with four columns 208 rather than a triangular arrangement. Accordingly, the first and second submersed lifting forks 300, 302 each comprise two different engagement surfaces (not shown) corresponding to a square pattern created by four equally spaced footplates.

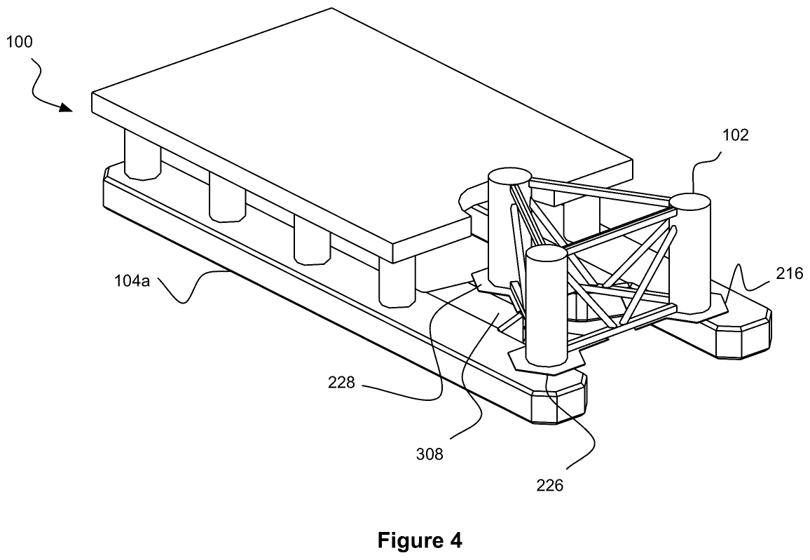

The floating wind turbine 102 as shown in FIG. 4 is engaged with the semi-submersible service vessel 100 in the second operating mode. Accordingly, the engagement surfaces 304, 306, 312a, 312b are engaging the corresponding first, second and third footplates 216, 226, 228. The third footplate 228 rests on both the third engagement surfaces 312a, 312b and bridges both the lateral projections 308, 310. Only the first lateral projection 308 mounted on the first hull 104a is shown and labelled in FIG. 4 for the purposes of clarity.

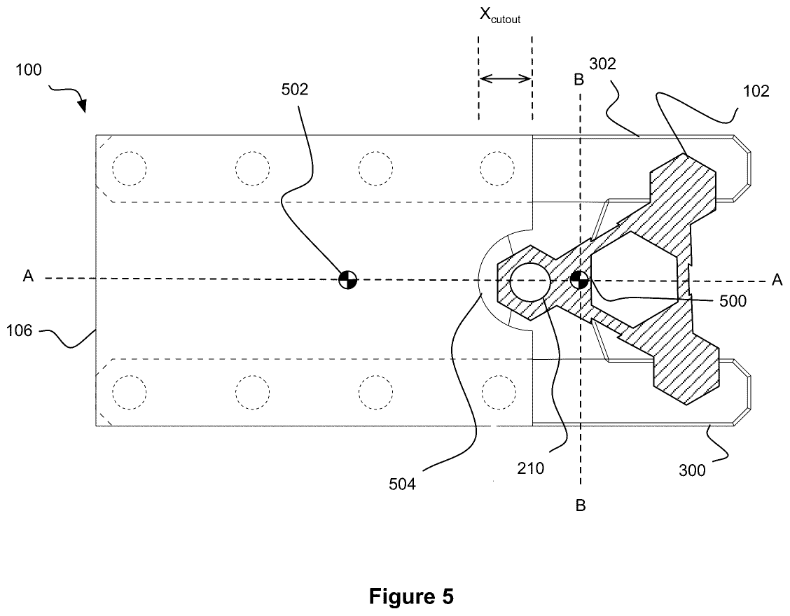

FIG. 5 also shows the floating wind turbine 102 mounted on the first and second submersed lifting forks 300, 302. FIG. 5 shows a plan view of the semi-submersible service vessel 100 and the floating wind turbine 102. For the purposes of clarity only the tower 210 component of the wind turbine is shown on the floating wind turbine 102.

Since the tower 210 and other components of the wind turbine are mounted on only one of the columns 208, a floating wind turbine centre of gravity 500 is located off-centre from a centre of the floating wind turbine 102 and is closer to the tower 210. The proximity of the floating wind turbine centre of gravity 500 to the tower 210 is dependent on the size, shape, and configuration of the floating wind turbine 102.

The floating wind turbine centre of gravity 500 is positioned between the first and second submersed lifting forks 300, 302. In some examples, the floating wind turbine centre of gravity 500 is aligned with the longitudinal centre axis A-A of the semi-submersible service vessel 100. Furthermore, the floating wind turbine centre of gravity 500 is also aligned with a transverse axis B-B across the first and second submersed lifting forks 300, 302. The transverse axis B-B is positioned between free ends 318a, 318b of the first and second submersed lifting forks 300, 302 and the ends 806 of the first and second submersed lifting forks 300, 302 attached to the hull 104. FIG. 8a further shows that the floating wind turbine centre of gravity 500 is aligned with a vertical axis C-C between the ends 318a, 318b, 806 of the first and second submersed lifting forks 300, 302. This means that the floating wind turbine centre of gravity 500 is positioned above the footprint of the first and second submersed lifting forks 300, 302. Accordingly, when the first and second submersed lifting forks 300, 302 exert an upward lifting force on the floating wind turbine 102, the first and second submersed lifting forks 300, 302 do not exert a turning moment on the floating wind turbine 102. The lifting operation will be discussed in more detail with respect to FIGS. 7a, 7b, and 8 below.

The physical centre 502 of the semi-submersible service vessel 100 is indicated in FIG. 5. In some examples, the centre of gravity (not shown) of the semi-submersible service vessel 100 is aligned with the centre of the semi-submersible service vessel 100. However, the centre of gravity of the semi-submersible service vessel 100 is dependent of the size, shape and configuration of various structures and equipment on the semi-submersible service vessel 100 and may therefore be remote from the physical centre 502 of the semi-submersible service vessel 100. Furthermore, the centre of gravity of the semi-submersible service vessel 100 will move as soon as the semi-submersible service vessel 100 lifts the weight of the floating wind turbine 102.

The floating wind turbine 102 is positioned with respect to the semi-submersible service vessel 100 such that the floating wind turbine centre of gravity 500 is as close as possible to the centre 502 of the semi-submersible service vessel 100. This improves the stability of the floating wind turbine 102 when mounted on the semi-submersible service vessel 100.

In some examples, the working deck 106 comprises a cut-out 504. The cut-out 504 is a semi-circular hole in the edge of the working deck 106 for receiving the tower 210. This means that the tower 210 can be positioned closer to the centre 502 of the semi-submersible service vessel 100. Accordingly, the tower 210 and the floating wind turbine 102 can be moved towards the centre 502 by a distance Xcutout.

In some examples, the periphery of the cut-out 504 can be lined with a shock absorbing material (not shown) such as rubber to protect the working deck 106 and/or the tower 210 in the scenario where the floating wind turbine 102 is maneuvered too close to the working deck 106.

Advantageously, since the floating wind turbine 102 is secure and stable on the first and second submersed lifting forks 300, 302, the tower 210 or the floating wind turbine 102 do not have to be actively secured to the semi-submersible service vessel 100. This means that fastenings such as sea fastenings, lashings, ropes, or other tethers need not to be provided between the semi-submersible service vessel 100 and the floating wind turbine 102. Having said this, optionally the tower 210 may be fastened to the working deck 106 in the vicinity of the cut-out 504 if the sea conditions are rough, but this is not necessary.

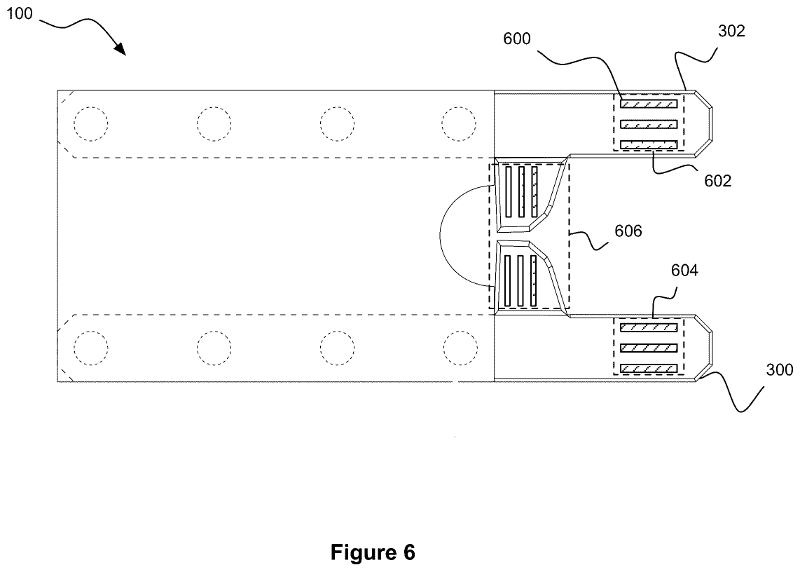

Reference will now be made to FIG. 6 to discuss another example. FIG. 6 shows a plan view of semi-submersible service vessel 100. The first and second submersed lifting forks 300, 302 comprise engagement surfaces 602, 604, 606. The engagement surfaces 602, 604, 606 are the same as the engagement surfaces 304, 306, 312a, 312b discussed in reference to the previous examples except that engagement surfaces 602, 604, 606 comprise a plurality of discrete shock absorbing elements 600. For the purposes of clarity, only one shock absorbing element 600 is labelled in FIG. 6.

FIG. 6 shows three shock absorbing elements 600 the engagement surfaces 602, 604, 606. In other examples, there can be any number of shock absorbing elements 600 mounted on the engagement surfaces 602, 604, 606. In some examples, shock absorbing elements 600 are also arranged to increase the friction between the first and second submersed lifting forks 300, 302 and the underside 224 of the floating wind turbine 102. In some examples, shock absorbing elements 600 comprise an elastic material such as rubber.

Whist FIG. 6 shows discrete shock absorbing elements 600, in some other examples, the engagement surfaces 602, 604, 606 are completely covered in a layer of elastic material such as rubber. In some examples the elastic material has a non-linear elastic response, e.g. initial deformation of the elastic material is “soft” and then becoming “hard” when full contact deformation is reached.

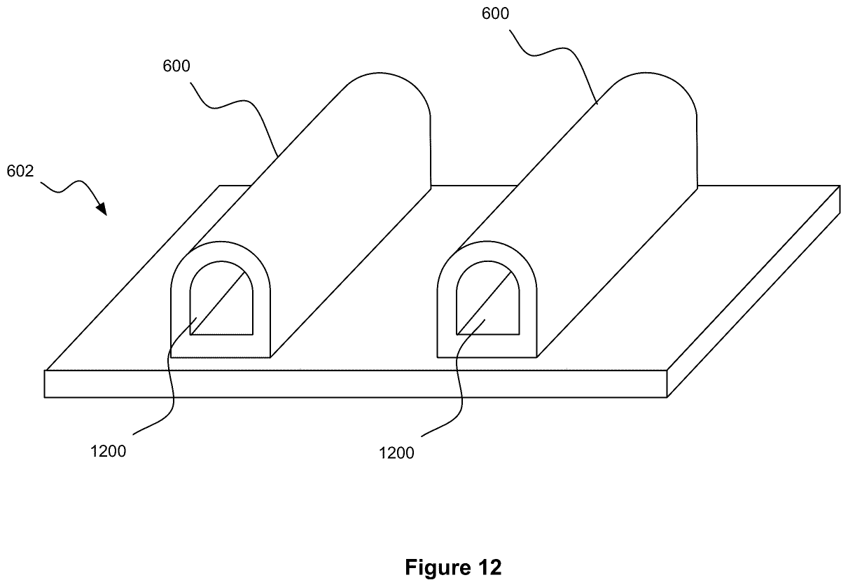

The shock absorbing elements 600 are further described in reference to FIG. 12. FIG. 12 shows a close-up perspective view of an engagement surface 602 on the first submersed lifting fork 300. In some examples the shock absorbing elements 600 are rubber fenders 600 to further prevent slipping between the semi-submersible service vessel 100 and the floating wind turbine 102.

The rubber fenders 600 are elongate members comprising a “D” shaped cross section defining an internal conduit 1200. The rubber fenders 600 are flexible and are arranged to deform when the rubber fenders 600 are squashed between the hull 104a and the underside 224 of the floating wind turbine 102. The internal conduit 1200 may trap a pillow of water which can act as a cushion when deformed during engagement.

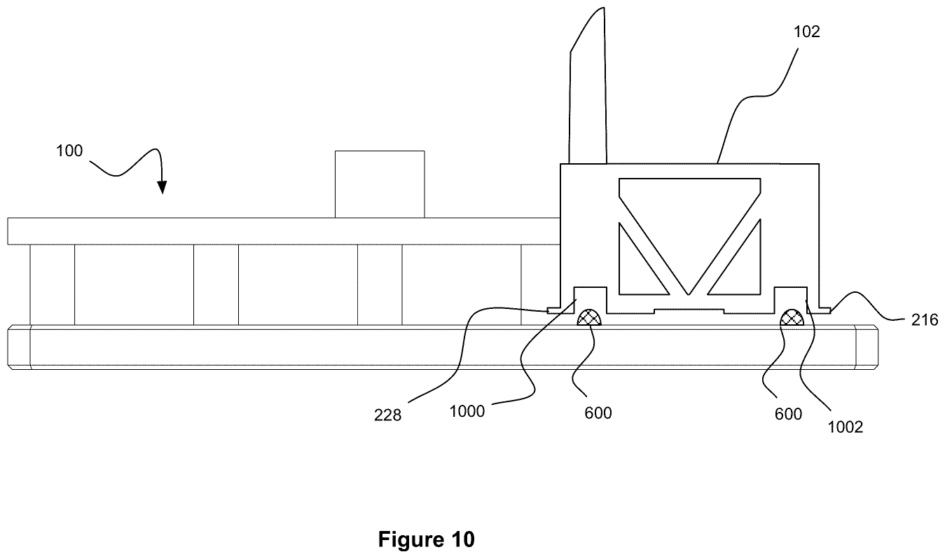

In order to increase the friction between the hull 104a and the floating wind turbine 102 during engagement, the underside 224 of the floating wind turbine 102 can have a plurality of recesses 1000, 1002 (best shown in FIG. 10) each for receiving a rubber fender 600. In this way, the rubber fender 600 is seated in a recess when the first and second submersed lifting forks 300, 302 engage the underside of the floating wind turbine 102. In some examples, both the underside 224 of the floating wind turbine 102 and the engagement surfaces 602, 604, 606 can have the rubber fenders 600. In other examples, on the underside 224 of the floating wind turbine 102 can have the rubber fenders 600.

FIG. 10 shows a schematic cross-sectional side view of the semi-submersible service vessel 100 and the floating wind turbine 102. In some examples, the underside 224 in the footplates 216, 228 comprise recesses 1000, 1002 for receiving the rubber fenders 600. Only two of the footplates 216, 228 are shown in FIG. 10, but the other footplate 226 can also comprise a recess for receiving a rubber fender 600. As can be seen from FIG. 10, the rubber fender 600 projects in to the recesses 1000, 1002 and this further increases the friction between the hull 104 and the floating wind turbine 102. FIG. 10 shows the rubber fenders 600 projecting into the recesses 1000, 1002, the hull 104 may additionally or alternatively comprise integral studs or other projections for engaging with the recesses 1000, 1002. In another example (not shown) the recesses 1000, 1002 may be provided on the hull 104 and the rubber fender 600 or projecting integral stud are formed on the underside 224 of the floating wind turbine 102.

In some examples, the engagement surfaces 602, 604, 606 may comprise one or more recesses (not shown) for trapping water for dampening shocks between the engagement surfaces 602, 604, 606 and the underside 224 of the floating wind turbine 102. The water pillow acts as a shock absorber and further prevents damage caused between the engagement surfaces 602, 604, 606 and the underside 224 of the floating wind turbine 102 when the semi-submersible service vessel 100 is raised from the first draft d1 to the second draft d2.

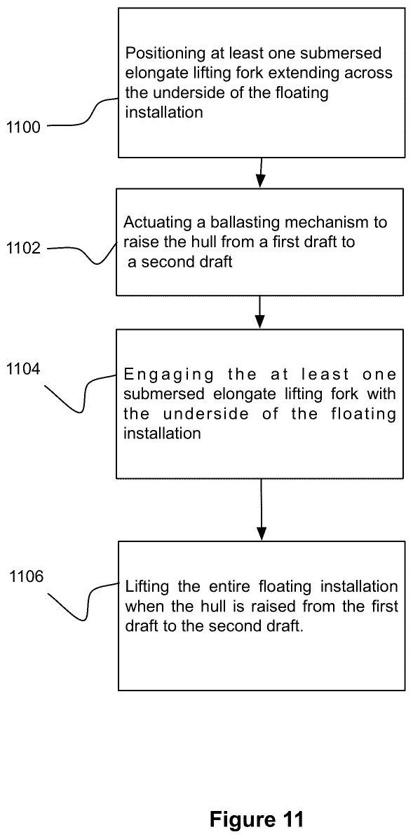

The lifting operation of the semi-submersible service vessel 100 will now be described in reference to FIGS. 7a, 7b, 8a, 8b and 11. FIGS. 7a and 7b show side views of the semi-submersible service vessel 100 and the floating wind turbine 102 at different stages of engagement. FIGS. 8a and 8b shows a side view of the semi-submersible service vessel 100 and the floating wind turbine 102 at different stages of engagement. FIG. 11 shows a flow diagram of method of servicing the floating wind turbine 102 with the semi-submersible service vessel 100.

The semi-submersible service vessel 100 approaches the floating wind turbine 102 in the first operating mode. This means that the hull 104 of the semi-submersible service vessel 100 is at the first draft d1 and the hull 104 is lower in the water. Accordingly the first and second submersed lifting forks 300, 302 are submerged at a depth which is deeper than the underside 224 of the floating wind turbine 102. At this point, there is no engagement between the semi-submersible service vessel 100 and the floating wind turbine 102.

The semi-submersible service vessel 100 is maneuvered to position the submersed elongate lifting forks 300, 302 to extend across the underside 224 of the floating wind turbine 102 as shown in step 1100 of FIG. 11.

The ballasting system 900 is then actuated to deballast and to raise the hull 104 from the first draft d1 to the second draft d2 as shown in step 1102 of FIG. 11. The ballasting system 900 comprises at least one ballast tank 906. FIG. 9 shows a plurality of ballast tanks 906 distributed along the hull 104, but only one ballast tank 906 has been labelled for the purposes of clarity. In some other examples, there can be a single ballast tank 906 mounted in the hull 104. The ballast tank 906 is coupled to a pump 904 for selectively moving water into and out of the ballast tank 906. Emptying the ballast tank 906 decreases the draft of the hull 104 and the semi-submersible service vessel 100 is raised out of the water to a desired draft e.g. the second draft d2.

Accordingly, actuating the ballast system 900 and deballasting the ballast tanks 906, raises the hull 104 and the first and second submersed lifting forks 300, 302 engage with the underside 224 of the floating wind turbine 102 as shown in step 1104 in FIG. 11.

As the hull 104 is raised from the first draft d1 to the second draft d2, the first and second submersed lifting forks 300, 302 exert a lifting force on the underside 224 of the floating wind turbine 102.

As the hull 104 continues to be raised by the change in buoyancy caused by the ballasting system, the first and second submersed lifting forks 300, 302 lift the entire floating wind turbine 102. As this happens, the weight of the floating wind turbine 102 is supported by the first and second submersed lifting forks 300, 302. This can be seen in FIG. 7b whereby the floating wind turbine 102 has been lifted by the semi-submersible service vessel 100.

The force of the weight of the floating wind turbine 102 on the first and second submersed lifting forks 300, 302 causes a frictional force between the first and second submersed lifting forks 300, 302 and the underside 224 of the floating wind turbine 102. In this way, the floating wind turbine 102 is secured on the first and second submersed lifting forks 300, 302 due to the weight of the floating wind turbine 102 on the first and second submersed lifting forks 300, 302. This means that the floating wind turbine 102 is fixed to the semi-submersible service vessel 100 and maintenance can be carried out on the floating wind turbine 102 without the waves and wind causing relative motion between them.

As can be seen from FIG. 8b, the distance dL that the floating wind turbine 102 is lifted is the difference between the first draft d1 and the second draft d2. The floating wind turbine 102 is represented in FIGS. 8a and 8b as the floating wind turbine centre of gravity 500. FIGS. 8a and 8b show that the floating wind turbine centre of gravity 500 has been raised by the distance dL. The resultant lifting force FL exerted by the first and second submersed lifting forks 300, 302 acts in a direction towards the floating wind turbine centre of gravity 500. Accordingly, this means that the resultant lifting force FL does not create a turning moment about the floating wind turbine centre of gravity 500. The entire floating wind turbine 102 is lifted upwards by the lifting distance dL.

In some examples, and as shown in FIG. 7b, the floating wind turbine 102 is partially submerged when the semi-submersible service vessel 100 is operating in the second mode at the second draft d2. This means that the weight of the floating wind turbine 102 on the first and second submersed lifting forks 300, 302 is less than if the floating wind turbine 102 is completely raised out of the water. This means that the first and second submersed lifting forks 300, 302 can be smaller and designed to a lower maximum lifting force when the hull is raised from the first draft d1 to the second draft d2.

In some examples, the ballasting system 900 can adjust the depth of the hull 104 at the second draft d2. This can be used to modify the lifting force exerted by the first and second submersed lifting forks 300, 302 on the floating wind turbine 102. For example, if the size and weight of the floating wind turbine 102 varies, then the lifting force exerted by the first and second submersed lifting forks 300, 302 can be adjusted accordingly.

As mentioned previously, in some examples, the floating wind turbine 102 is tethered to the seafloor via a plurality of mooring lines 220a, 220b, 220c. In some examples, the mooring lines 220a, 220b, 220c are loosened or removed, so that the lifting force exerted on the underside 224 of the floating wind turbine 102 does not increase the tension in the mooring lines 220a, 220b, 220c.

However in some examples as shown in FIG. 7b, the plurality of mooring lines 220a, 220b, 220c are maintained tethered to the floating wind turbine 102 and the seafloor. In this case, the lifting force FL acts against the tension FT1, FT2, etc. in the mooring lines 220a, 220b, 220c. This causes the resultant downward force FFWT of the floating wind turbine 102 acting on the first and second submersed lifting forks 300, 302 to be increased. Accordingly the engagement between the floating wind turbine 102 and the semi-submersible service vessel 100 is improved and the floating wind turbine 102 is less likely to slip off the first and second submersed lifting forks 300, 302.

Optionally, one of the mooring lines 220c can be slackened and the other mooring lines 220a, 220b can remained tensioned when the floating wind turbine 102 is lifted by the semi-submersible service vessel 100. This can be advantageous to keep the mooring line 220c slack so that it is guided between the first and second hulls 104a, 104b.

In some examples the ballasting system 900 can be controlled to adjust and/or limit the increased tension in the mooring lines 220a, 220b, 220c. In this way, the lifting force FL can be lowered to prevent damage to the mooring lines 220a, 220b, 220c and/or their anchors 222a, 222b, 222c. For example, the ballasting system 900 can be controlled to adjust the hull 104 to be lowered to a third draft between the first draft d1 and the second draft d2. The lifting force FL exerted at the third draft will be less than the lifting force FL exerted at the second draft d2.

In some examples, the resultant downward force FFWT on the first and second submersed lifting forks 300, 302 can be further increased by adjusting the wind turbine ballast system 902. The wind turbine ballast system 902 comprises wind turbine ballast tanks 908 for adjusting the draft of the floating wind turbine 102. Once the floating wind turbine 102 is engaged with the first and second submersed lifting forks 300, 302, the wind turbine ballast tanks 908 can be flooded with water to increase the weight of the floating wind turbine 102 on the first and second submersed lifting forks 300, 302. This will increase the frictional forces between the semi-submersible service vessel 100 and the floating wind turbine 102.

In some examples the wind turbine ballast system 902 can be independently actuated from the semi-submersible service vessel 100. In other examples, a hose 910 can be connected between the wind turbine ballast system 902 and the semi-submersible service vessel 100. The hose 910 is in connection with a secondary ballast pump 912 arranged to pump water in and out of the wind turbine ballast tanks 908. Optionally a second hose 914 can connected the wind turbine ballast system 902 to the pump 904. This means that the pump 904 can control the ballasting of the ballasting system 900 on the semi-submersible service vessel 100 and the wind turbine ballast system 902. The wind turbine ballast system 902 can be adjusted after the semi-submersible service vessel 100 has engaged the floating wind turbine 102 as needed.

Optionally the ballasting system 900 is a dynamic system and is configured to adjust the heel and trim of the semi-submersible service vessel 100 during crane operations. Optionally the ballasting system 900 further comprises an active or passive arrangement to reduce roll and pitch motions of the semi-submersible service vessel 100.

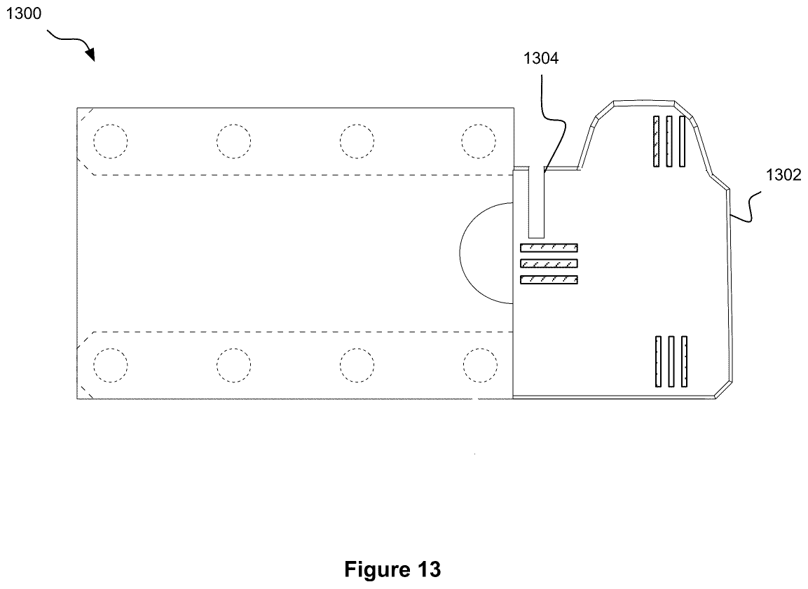

Turning to FIG. 13, another example will now be discussed. FIG. 13 shows a plan view of a semi-submersible service vessel 1300 according to an example. The semi-submersible service vessel 1300 is the same as discussed in reference to the previous Figures except that the hull 104 comprises a single submerged lifting fork 1302. As shown in FIG. 13, the submerged lifting fork 1302 is larger than the first and second submerged lifting forks 300, 302 as discussed above. In order to manage the mooring line 220c and/or the cable, a slot 1304 is provided in the single submersed lifting fork 1302. In this way a single submersed lifting fork 1302 can be used to lift the floating wind turbine 102.

Other examples will now be discussed in reference to FIGS. 14a, 14b, and 14c. FIGS. 14a, 14b, and 14c respectively show plan views of a semi-submersible service vessel 1400 according to different examples.

The semi-submersible service vessel 1400 is the same as discussed in reference to the previous Figures except that parts of the semi-submersible service vessel 1400 are moveable with respect to the hull 104.

FIG. 14a shows the first and second lateral projections 308, 310 are moveable with respect to the first and second submersed lifting forks 300, 302. The first and second lateral projections 308, 310 are moveable in a direction parallel to the transverse axis B-B. The first and second lateral projections 308, 310 can be moveable mounted to the first and second submersed lifting forks 300, 302 via a hydraulically actuated rack and pinion system (not shown), hydraulic pistons or hydraulic skidding. By moving the first and second lateral projections 308, 310 with respect to the first and second submersed lifting forks 300, 302, the semi-submersible service vessel 1400 can be adapted to different shapes and sizes of floating wind turbine 102.

In another example, two or more examples are combined. Features of one example can be combined with features of other examples.

FIG. 14b shows the first and second lateral projections 308, 310 are moveable with respect to the first and second submersed lifting forks 300, 302 in a direction parallel with the longitudinal axis A-A. Again, the first and second lateral projections 308, 310 can be moveable mounted to the first and second submersed lifting forks 300, 302 via a hydraulically actuated rack and pinion system (not shown), hydraulic pistons or hydraulic skidding. Optionally, the lateral projections 308, 310 can be moveable in two directions e.g. parallel to the axis A-A and the axis B-B.

FIG. 14c shows the first and second submersed lifting forks 300, 302 are moveable with respect to the first and second hulls 104a, 104b. The first and second submersed lifting forks 300, 302 are moveable in a direction parallel with the longitudinal axis A-A and/or the axis B-B. The first and second submersed lifting forks 300, 302 can be moveable mounted to the first and second hulls 104a, 104b via a hydraulically actuated rack and pinion system (not shown) hydraulic pistons or hydraulic skidding.

In another example, the semi-submersible service vessel 100 is arranged to engage with a feeder vessel (not shown) instead of the floating installation 102. In some examples, the feeder vessel is a flat bottomed barge (not shown) which is configured to be lifted on the underside of the hull. In this case, the feeder vessel can comprise one or more components or equipment for the semi-submersible service vessel 100. For example, the feeder vessel can be loaded wind turbine parts such as nacelles, blades, components, or other spare parts. The semi-submersible service vessel 100 is configured to engage with the feeder vessel in the same way as described in reference to the previous examples. For example, the first and second submersed lifting forks 300, 302 are positioned underneath the hull of the feeder vessel and first and second submersed lifting forks 300, 302 exert a lifting force on the feeder vessel. Accordingly, the first and second submersed lifting forks 300, 302 are fixed with respect to the hull of the feeder vessel and there is no relative motion between the semi-submersible service vessel 100 and the feeder vessel. The semi-submersible service vessel 100 then lifts the spare parts on to the working deck 106.

Optionally two or more of the examples shown in FIGS. 14a, 14b, and 14c can be combined. This can provide flexibility for the semi-submersible service vessel 1400 being able to service and maintain many different types of floating wind turbines 102.

Examples of the present disclosure have been discussed with particular reference to the examples illustrated. However it will be appreciated that variations and modifications may be made to the examples described within the scope of the disclosure.

1. A semi-submersible service vessel for a floating installation, the semi-submersible service vessel comprising:
a hull;
a ballasting system configured to selectively lower the hull to a first draft and raise the hull to a second draft, the second draft being smaller than the first draft; and
at least one submersed elongate lifting fork fixed to the hull, the at least one submersed elongate lifting fork configured to extend across an underside of the floating installation and engage the underside of the floating installation when the hull is raised from the first draft to the second draft; wherein
the at least one submersed elongate lifting fork is configured to lift the entire floating installation when the hull is raised from the first draft to the second draft.

2. The semi-submersible service vessel according to claim 1, wherein the at least one submersed elongate lifting fork is configured to exert a resultant lifting force on the underside of the floating installation towards a centre of gravity of the floating installation when the hull is raised from the first draft to the second draft.

3. The semi-submersible service vessel according to claim 1, wherein the at least one submersed elongate lifting fork is an integral portion of the hull.

4. The semi-submersible service vessel according to claim 1, wherein the at least one submersed elongate lifting fork includes a pair of lifting forks.

5. The semi-submersible service vessel according to according claim 4, wherein each of the lifting forks comprises a lateral projection extending towards another lifting fork.

6. The semi-submersible service vessel according to claim 5, wherein the lateral projection comprises a guide surface arranged to guide cables or mooring lines between the pair of lifting forks.

7. The semi-submersible service vessel according to claim 4, wherein a centre of gravity of the floating installation is positioned between the pair of lifting forks.

8. The semi-submersible service vessel according to claim 1, wherein the at least one submerged elongate lifting fork extends across the underside of the floating installation from a first side of the floating installation to a second side of the floating installation.

9. The semi-submersible service vessel according to claim 1, wherein the at least one submerged elongate lifting fork comprises at least one engagement surface configured to engage at least one reciprocal surface on the underside of the floating installation.

10. The semi-submersible service vessel according to claim 9, wherein the at least one engagement surface comprises a profile and the at least one reciprocal surface comprises a reciprocal profile.

11. The semi-submersible service vessel according to claim 9, wherein at least one of the at least one engagement surface or the at least one reciprocal surface comprise a dampener configured to absorb shocks between the at least one submerged elongate lifting fork and the floating installation.

12. The semi-submersible service vessel according to claim 11, wherein the dampener is a rubber fender.

13. The semi-submersible service vessel according to claim 9, wherein least one of the at least one engagement surface or the at least one reciprocal surface comprise a recess for trapping water for dampening shocks between the at least one engagement surface and the at least one reciprocal surface when engaged.

14. The semi-submersible service vessel according to claim 1, wherein the floating installation is tethered to the seafloor via at least one mooring line.

15. The semi-submersible service vessel according to claim 14, wherein tension in the at least one mooring line opposes a lifting force when the hull is raised to the second draft.

16. The semi-submersible service vessel according to claim 1, wherein the second draft of the hull corresponds to a threshold resultant lifting force.

17. The semi-submersible service vessel according to claim 16, wherein the ballasting system is configured move the hull from the second draft to a third draft and modify a resultant lifting force.

18. The semi-submersible service vessel according to claim 16, wherein a resultant lifting force is less than a threshold mooring line tension.

19. The semi-submersible service vessel according to claim 1, wherein a lifting force exerted by the at least one submerged elongate lifting fork does not cause a turning moment about a centre of gravity of the floating installation.

20. The semi-submersible service vessel according to claim 1, wherein the ballasting system is connectable to a one or more ballast tanks mounted on the floating installation and arranged to adjust ballast in the ballast tanks.

21. The semi-submersible service vessel according to claim 1, wherein the floating installation is a floating wind turbine.

22. A method of servicing a floating installation with a semi-submersible service vessel, the method comprising:
positioning at least one submersed elongate lifting fork fixed to a hull of the semi-submersible service vessel such that the at least one submersed elongate lifting fork extends across an underside of the floating installation;
actuating a ballasting system to raise the hull from a first draft a second draft;
engaging the at least one submersed elongate lifting fork with the underside of the floating installation when the hull is raised from the first draft to the second draft; and
exerting a lifting force on the underside of the floating installation with the at least one submersed elongate lifting fork and lifting the entire floating installation when the hull is raised from the first draft to the second draft.

23. The method according to claim 22, further comprising:
increasing tension in at least one mooring line tethering the floating installation to the seafloor when the hull is raised from the first draft to the second draft.
